(19) United States
(12) Patent Application Publication
(10) Pub. No.: US 2006/0083928 A1
(43) Pub. Date: Apr. 20, 2006

(54) Resin composition

(75) Inventors: Tomoko Miyagawa, Kawasaki-shi (JP); Mineo Nouchi, Kawasaki-shi (JP); Kiyonori Furuta, Kawasaki-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: AJINOMOTO CO. INC, Tokyo (JP)

(21) Appl. No.: 11/249,455

(22) Filed: Oct. 14, 2005

(30) Foreign Application Priority Data
Oct. 15, 2004 (JP) 301574/2004

(51) Int. Cl. B32B 27/38; C08L 63/00; C08L 55/00; B32B 37/00

(52) U.S. Cl. 428/413; 428/901; 525/107; 525/523; 525/528; 525/529

(57) ABSTRACT

Resin compositions containing (A) a resin having a polybutadiene structure in a molecule, (B) a thermosetting resin, and (C) a compound having 2 or more mercapto groups in a molecule and/or a compound having a disulfide bond in a molecule are useful for protecting flexible printed circuit boards.

### CROSS REFERENCES TO RELATED APPLICATIONS

This application claims priority to Japanese Patent Application No. 301574/2004, filed on Oct. 15, 2004, which is incorporated herein by reference in its entirety.

### BACKGROUND OF THE INVENTION

1. Field of the Invention

The present invention relates to resin compositions which can be preferably used as overcoating agents to protect the circuit surface of a flexible printed circuit board used for TCP (Tape Carrier Package), COF (Chip On Flexible or Film) and the like. More particularly, the present invention relates to flexible printed circuit boards having a surface protected by such a resin composition and an electronic device housing such a circuit board.

2. Discussion of the Background

Generally, a flexible printed circuit board (FPC) utilized for TCP, COF, etc. mainly consists of a substrate comprising a polyester terephthalate or polyimide film having a conductor layer (conductor circuit layer) having a circuit formed on one surface or both surfaces thereof, and a surface protecting film to protect the surface of the substrate. To form an insulating protecting film for an FPC, a method comprising adhering, to a substrate, a cover-lay film obtained by punching a polyimide film into a desired shape using a metal mold and forming an adhesive layer thereon, and a method comprising printing a varnish resin composition (overcoating agent) to form a desired pattern by a screen printing and curing the composition are generally known. Since the method using a cover-lay film is disadvantageous in regard to workability and costs, the method comprising applying an overcoating agent by screen printing is becoming mainstream.

The resin composition to be used as an overcoating agent for an FPC is required to exhibit flexibility in its cured product and resist warping. As a method to impart such properties, a method using a resin having a polybutadiene skeleton can be mentioned. JP-A-11-71551 and JP-A-11-199669 disclose that an overcoating agent for a flexible circuit, which contains a particular polybutadiene polyol, polyester polyol, and polybutadiene block isocyanate and has a polybutadiene skeleton, and a resin composition containing a polyimide resin, polybutadiene polyol, and polyblock isocyanate are superior in properties such as flexibility, warping, and the like, and are preferable as an overcoating agent for a flexible circuit.

On the other hand, the demand for thin and compact electronic devices has been increasing in recent years, and ultrafine wiring for FPCs is progressing. However, an FPC having fine-pitched wiring more markedly suffers from the effect of any warping of a surface protecting film due to heat, and shows a strikingly decreased yield. Therefore, a resin composition for an overcoating agent that more strongly suppresses the warp caused by the heat has been demanded.

### SUMMARY OF THE INVENTION

Accordingly, it is one object of the present invention to provide novel resin compositions which are useful as overcoating agents for a flexible printed circuit board.

It is another object of the present invention to provide novel resin compositions which are useful as overcoating agents for a flexible printed circuit board, which suppresses warping caused by heat.

These and other objects, which will become apparent during the following detailed description, have been achieved by the inventors' discovery that a cured product of a resin composition comprising (A) a resin having a polybutadiene structure in a molecule, (B) a thermosetting resin, and (C) a compound having 2 or more mercapto groups in a molecule and/or a compound having a disulfide bond in a molecule shows superior flexibility and a small amount of warping caused by heat.

Accordingly, the present invention provides the following:

(1) A resin composition, comprising:

(A) a resin having a polybutadiene structure in a molecule;

(B) a thermosetting resin; and

(C) a compound having 2 or more mercapto groups in a molecule and/or a compound having a disulfide bond in a molecule.

(2) The resin composition of the above-mentioned (1), wherein the component (A) is a resin having a polybutadiene structure and a polyurethane structure in a molecule.

(3) The resin composition of the above-mentioned (1), wherein the component (A) is a resin having a polybutadiene structure, a polyurethane structure, and a polyimide structure in a molecule.

(4) The resin composition of the above-mentioned (1), wherein the component (A) is a modified polyimide resin obtained by reacting a bifunctional hydroxyl group-terminated polybutadiene, a diisocyanate compound, and a tetracarboxylic acid dianhydride.

(5) The resin composition of the above-mentioned (1), wherein the component (A) is a modified polyimide resin obtained by reacting a tetracarboxylic acid dianhydride with a polybutadiene diisocyanate composition wherein the polybutadiene diisocyanate composition is obtained by reacting a bifunctional hydroxyl group-terminated polybutadiene with a diisocyanate compound at a functional group equivalent ratio exceeding 1 equivalent of isocyanate groups of the diisocyanate compound per equivalents of hydroxyl groups of the bifunctional hydroxyl group-terminated polybutadiene.

(6) The resin composition of the above-mentioned (1), wherein the component (A) is a modified polyimide resin obtained by reacting a tetracarboxylic acid dianhydride with a polybutadiene diisocyanate composition wherein the polybutadiene diisocyanate composition is obtained by reacting a bifunctional hydroxyl group-terminated polybutadiene with a diisocyanate compound at a functional group equivalent ratio of 1:1.5 to 1:2.5 of hydroxyl groups of the bifunctional hydroxyl group-terminated polybutadiene:isocyanate groups of the diisocyanate compound.

(7) The resin composition of the above-mentioned (1), wherein the component (A) is a modified polyimide resin obtained by reacting a tetracarboxylic acid dianhydride with a polybutadiene diisocyanate composition, wherein the polybutadiene diisocyanate composition is obtained by reacting a bifunctional hydroxyl group-terminated polybutadiene with a diisocyanate compound at a functional group equivalent ratio of 1:1.5 to 1:2.5 of hydroxyl groups of the bifunctional hydroxyl group-terminated polybutadiene:isocyanate groups of the diisocyanate compound, at a ratio which allows the functional group equivalent X of the isocyanate groups of the starting material diisocyanate compound, the functional group equivalent W of the hydroxyl groups of the starting material bifunctional hydroxyl-terminated polybutadiene, and the functional group equivalent Y of the acid anhydride groups of the tetracarboxylic acid dianhydride to satisfy the relation of Y>X−W≧Y/5 (W>0, X>0, Y>0).

(8) The resin composition of any of the above-mentioned (4)-(7), wherein the modified polyimide resin is a modified linear polyimide resin obtained by further reacting an additional isocyanate compound and the modified linear polyimide resin at a ratio which allows the functional group equivalent X of the isocyanate groups of the starting material diisocyanate compound, the functional group equivalent W of the hydroxyl groups of the starting material bifunctional hydroxyl-terminated polybutadiene, the functional group equivalent Y of the acid anhydride groups of the tetracarboxylic acid dianhydride, and the functional group equivalent Z of isocyanate groups of the newly reacted isocyanate compound to satisfy the relation of Y−(X−W)>Z≧0(W>0, X>0, Y>0, Z>0).

(9) The resin composition of any of the above-mentioned (4)-(6), wherein the bifunctional hydroxyl group-terminated polybutadiene has a number average molecular weight of 800 to 10000.

(10) The resin composition of the above-mentioned (1), wherein the component (A) is a resin having a polyurethane structure represented by the following formula (1-a): 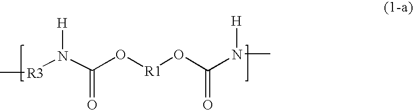
wherein R1 is a residue obtained by removing hydroxyl groups from a bifunctional hydroxyl group-terminated polybutadiene, and R3 represents a residue obtained by removing isocyanate groups from a diisocyanate compound.

(11) The resin composition of the above-mentioned (1), wherein the component (A) is a modified polyimide resin having, in a molecule, a polybutadiene structure represented by the following formula (1-a): 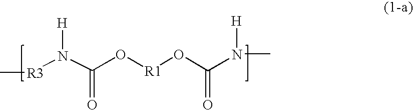
wherein R1 is a residue obtained by removing hydroxyl groups from a bifunctional hydroxyl group-terminated polybutadiene, and R3 is a residue obtained by removing isocyanate groups from a diisocyanate compound
and a polyimide structure represented by the formula (1-b) 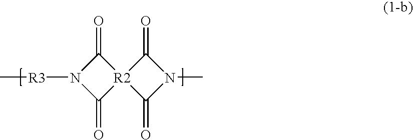
wherein R2 is a residue obtained by removing acid anhydride groups from a tetracarboxylic acid dianhydride, and R3 is as defined above.

(12) The resin composition of any of the above-mentioned (1)-(11), wherein the component (B) is an epoxy resin.

(13) The resin composition of the above-mentioned (12), further comprising an epoxy curing agent.

(14) The resin composition of any of the above-mentioned (1)-(13), wherein a mass ratio of component (A):component (B) is 100:1 to 1:1, and the total content of components (A) and (B) in the resin composition is not less than 60 mass %.

(15) The resin composition of any of the above-mentioned (1)-(14), wherein a mass ratio of component (A):component (C) is 1000:1 to 10:1.

(16) The resin composition of any of the above-mentioned (1)-(15), further comprising a filler.

(17) The resin composition of any of the above-mentioned (16), wherein the content of the filler in the resin composition is 5 to 50 mass %.

(18) The resin composition of any of the above-mentioned (1)-(17), which is a varnish resin composition further comprising an organic solvent.

(19) The resin composition of the above-mentioned (18), wherein the content of an organic solvent in the resin composition is 20 to 60 mass %.

(20) The resin composition of any of the above-mentioned (1)-(19), which is used for surface protection of a flexible printed circuit board.

(21) A flexible printed circuit board having a surface protected by the resin composition of any of the above-mentioned (1)-(17).

(22) A flexible printed circuit board having a protected surface, which is obtained by applying a varnish of the resin composition of the above-mentioned (18) or (19) to a given part of the flexible printed circuit board and drying the varnish.

(23) An electronic device comprising a flexible printed circuit board of the above-mentioned (21) or (22).

The resin composition of the present invention can be preferably used as an overcoating agent for a flexible printed circuit board, since a cured product thereof has superior flexibility and exhibits only a small amount of warping due to heat, which is attributable to the presence of a resin containing a polybutadiene structure in a molecule.

### DETAILED DESCRIPTION OF THE PREFERRED EMBODIMENTS

The resin composition of the present invention is mainly characterized in that it contains a resin having a polybutadiene structure in a molecule, a thermosetting resin, and a compound having 2 or more mercapto groups in a molecule and/or a compound having a disulfide bond in a molecule.

To be specific, the present invention can afford a resin composition containing a resin having a polybutadiene structure that affords superior flexibility to a cured product thereof and a thermosetting resin, which shows markedly reduced warping when the composition is cured in layers, by adding a compound having 2 or more mercapto groups in a molecule and/or a compound having a disulfide bond in a molecule to the resin composition. The composition is useful as a resin composition for a flexible printed circuit board, since it has flexibility due to the resin having a polybutadiene structure in a molecule and shows reduced warping on curing. It is particularly preferable as a resin composition for surface protection of a flexible printed circuit board (overcoating agent for a flexible printed circuit board).

While the “resin having a polybutadiene structure in a molecule,” which is component (A) in the present invention, is not particularly limited, it is generally a copolymer of polybutadiene and other compound, and preferably a resin having a polybutadiene structure and a polyurethane structure in a molecule, from the aspect of flexibility.

As the resin having a polybutadiene structure and a polyurethane structure in a molecule, a resin having a repeating unit represented by the following formula (1-a) in a molecule can be mentioned. 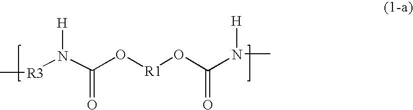
In formula (1-a), R1 is a residue obtained by removing the hydroxyl groups of the bifunctional hydroxyl group-terminated polybutadiene, and R3 is a residue obtained by removing the isocyanate groups of the diisocyanate compound.

The “resin having a polybutadiene structure in a molecule,” which is component (A) in the present invention, is particularly preferably a resin having a polyimide structure in addition to the polybutadiene structure and the polyurethane structure in a molecule, in view of the heat resistance necessary for application to a flexible printed circuit board.

As a resin having a polybutadiene structure, a polyurethane structure and a polyimide structure in a molecule, a modified polyimide resin having a repeating unit represented by the following formulas (1-a) and (1-b) in a molecule can be mentioned. 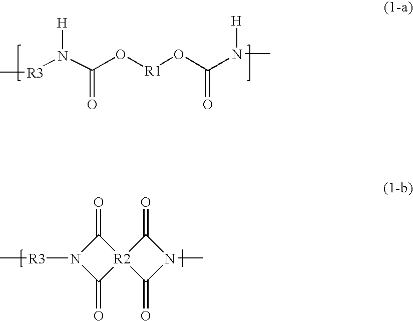
In formulae (1-a) and (1-b), R1 is a residue obtained by removing the hydroxyl groups of the bifunctional hydroxyl group-terminated polybutadiene, R2 is a residue obtained by removing the acid anhydride groups of the tetracarboxylic acid dianhydride, and R3 is a residue obtained by removing the isocyanate groups of the diisocyanate compound.

In the present invention, a particularly preferable above-mentioned modified polyimide resin can be obtained by reacting three components of

(a) bifunctional hydroxyl group-terminated polybutadiene,

(b) diisocyanate compound, and

(c) tetracarboxylic acid dianhydride.

As the bifunctional hydroxyl group-terminated polybutadiene, bifunctional hydroxyl group-terminated polybutadienes having a number average molecular weight of 800 to 10000 is preferable. As the polybutadiene structure of the formula (1-a), such structure wherein R1 is a residue of bifunctional hydroxyl group-terminated polybutadiene having a number average molecular weight of 800 to 10000 less the hydroxyl groups is preferable. When the number average molecular weight of the bifunctional hydroxyl group-terminated polybutadiene is not more than 800, the modified polyimide resin tends to lack flexibility, and when it is not less than 10000, the modified polyimide resin tends to have insufficient compatibility with a thermosetting resin, and insufficient heat resistance. In the present invention, the number average molecular weight is measured by a gel permeation chromatography (GPC) method (based on polystyrene). The number average molecular weight can be determined by GPC method by measurement using LC-9A/RID-6A manufactured by Shimadzu Corporation as a measurement apparatus, Shodex K-800P/K-804L/K-804L manufactured by SHOWA DENKO K.K. as a column and chloroform as a mobile phase at a column temperature of 40° C., and calculation using an analytical curve of standard polystyrene.

The number of polybutadiene structures (1-a) present per molecule in the modified polyimide resin is generally 1 to 10,000, preferably 1 to 100, and the number of polyimide structures (1-b) present is generally 1 to 100, preferably 1 to 10.

While the number average molecular weight of the modified polyimide resin is not particularly limited, it is generally 5000 to 200000, preferably 10000 to 100000.

The respective components (a)-(c) to be the starting materials of the modified polyimide resin can be represented by the following formulas (a)-(c), respectively. 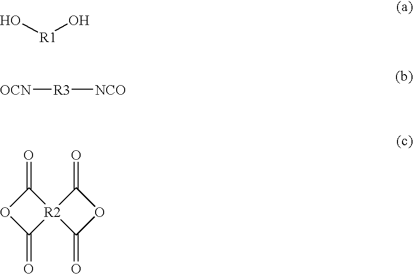
wherein each symbol in the formula is as defined above.

To efficiently obtain the modified polyimide resin of the present invention, the following steps are preferable.

First, the polybutadiene of component (a) and the diisocyanate compound of component (b) are reacted at an equivalent ratio exceeding 1 of the isocyanate groups of the diisocyanate compound to the hydroxyl groups of the polybutadiene to give a composition containing polybutadiene diisocyanate. In other words, the polybutadiene of component (a) and the diisocyanate compound of component (b) are reacted in relative amounts such that the functional group equivalent ratio of the isocyanate groups of the diisocyanate compound to the hydroxyl groups of the bifunctional hydroxyl-terminated polybutadiene is greater than 1. The polybutadiene diisocyanate can be represented by the following formula (a-b). 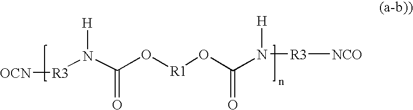
wherein R1 is a residue obtained by removing the hydroxyl groups of the bifunctional hydroxyl group-terminated polybutadiene, R3 is a residue obtained by removing the isocyanate groups of the diisocyanate compound, and n is an integer of not less than 1 and not more than 100 (1≦n≦100), preferably not less than 1 and not more than 10 (1≦n≦10). In the polybutadiene isocyanate represented by the formula (a-b), R1 in the formula is preferably a residue of bifunctional hydroxyl group-terminated polybutadiene having a number average molecular weight of 800 to 10000 less a hydroxyl group.

The reaction ratio of polybutadiene and a diisocyanate compound is preferably a functional group equivalent ratio of 1:1.5 to 1:2.5 of the isocyanate groups of the diisocyanate compound to the hydroxyl groups of the polybutadiene.

Next, a tetracarboxylic acid dianhydride is reacted with the polybutadiene diisocyanate composition. While the reaction ratio of the tetracarboxylic acid dianhydride is not particularly limited, it is preferable to not leave an isocyanate group in the composition as much as possible, and a reaction at a ratio satisfying Y>X−W≧Y/5(W>0, X>0, Y>0), wherein X is the functional group equivalent weight of the isocyanate groups of the starting material diisocyanate compound, W is the functional group equivalent weight of the hydroxyl groups of the starting material bifunctional hydroxyl group-terminated polybutadiene, and Y is the functional group equivalent weight of the acid anhydride groups of the tetracarboxylic acid dianhydride is preferable.

The modified polyimide resin thus obtained contains, as mentioned above, both a polybutadiene structure represented by the formula (1-a) and a polyimide structure represented by the formula (1-b) in a molecule. In addition, the modified polyimide resin in the present invention preferably comprises a modified polyimide having a structure represented by the following formula (a-b-c) as a main component: 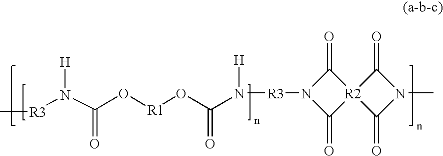
wherein R1 is a residue obtained by removing the hydroxyl groups of the bifunctional hydroxyl group-terminated polybutadiene, R2 is a residue obtained by removing the acid anhydride groups of the tetracarboxylic acid dianhydride, R3 is a residue obtained by removing the isocyanate groups of the diisocyanate compound, and n and m are each an integer of not less than 1 and not more than 100 (1≦n, m≦100). n and m are each preferably an integer of not less than 1 and not more than 10 (1≦n, m≦10). As the polybutadiene structure in the formula (a-b-c), a structure wherein R1 in the formula is a residue obtained by removing the hydroxyl groups of the bifunctional hydroxyl group-terminated polybutadiene having a number average molecular weight of 800 to 10000 is preferable.

To try not to leave any isocyanate groups remaining in the polybutadiene diisocyanate composition as much as possible, it is preferable to confirm disappearance of isocyanate group by FT-IR etc. during the reaction. The terminal group of the modified polyimide resin thus obtained can be represented by the following formula (1-c) or the following formula (1-d): 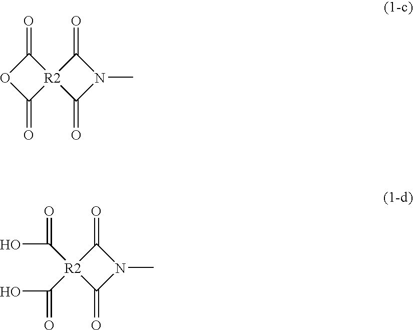
wherein each symbol in the formula is as defined above.

In the production of the modified polyimide resin, the modified polyimide resin having a higher molecular weight can be obtained by reacting the polybutadiene diisocyanate composition with the tetracarboxylic acid dianhydride and further reacting the resulting reaction mixture with a diisocyanate compound. In this case, while the reaction ratio of the diisocyanate compound is not particularly limited, a reaction at a ratio satisfying Y−(X−W)>Z≧0 (W>0, X>0, Y>0, Z>0), wherein X is the functional group equivalent weight of the isocyanate groups of the starting material diisocyanate compound, W is the functional group equivalent weight of the hydroxyl groups of the starting material bifunctional hydroxyl group-terminated polybutadiene, Y is the functional group equivalent weight of the acid anhydride groups of the tetracarboxylic acid dianhydride, and Z is the functional group equivalent weight of the isocyanate groups of the diisocyanate compound to be newly reacted is preferable.

The modified polyimide resin in the present invention has two chemical structural units of the polybutadiene structure represented by the above-mentioned formula (1-a) and the polyimide structure represented by the above-mentioned formula (1-b). Generally, to impart flexibility to a resin composition, a rubber resin such as polybutadiene resin is directly mixed with the resin composition. However, a nonpolar rubber resin easily causes phase separation in a high polar thermosetting resin composition, and particularly when the content ratio of rubber resin is high, a stable composition is difficult to obtain. Furthermore, a resin composition comprising a rubber resin often fails to afford sufficient heat resistance. In contrast, a polyimide resin shows relatively good compatibility with a thermosetting resin composition because it has heat resistance and high polarity. Since the modified polyimide resin of the present invention has both the polyimide structure and the polybutadiene structure to afford flexibility in a single molecule, it becomes a material superior in both properties of flexibility and heat resistance. Furthermore, since the resin has good compatibility with a thermosetting resin, it becomes a material suitable for obtaining a stable thermosetting resin composition.

The constitution ratio of the polybutadiene structure and the polyimide structure in the modified polyimide resin in the present invention can be changed by adjusting the reaction ratio of starting materials. When the ratio of the polybutadiene structure is higher, the resin composition of the present invention becomes a material more superior in flexibility, and when the ratio of the polyimide structure is higher, it becomes a material more superior in heat resistance. In addition, a compound having a polybutadiene structure or a polyimide structure is known to have a tendency to exhibit lower dielectric constant and dielectric loss tangent values. Since the modified polyimide resin in the present invention has both skeletons, the resin composition of the present invention can be an insulating material which is also superior in dielectric property. Particularly when the ratio of the polybutadiene structure in the modified polyimide resin is high, the composition becomes a material even more superior in dielectric property.

The bifunctional hydroxyl group-terminals of the bifunctional hydroxyl group-terminated polybutadiene, which is component (a) to be a starting material for the modified polyimide resin in the present invention, means that both terminals of the polybutadiene are hydroxyl groups. As the polybutadiene, one wherein a part of the unsaturated bond in a molecule is hydrogenated can be also used. As specific examples of the bifunctional hydroxyl group-terminated polybutadiene include, for example, G-1000, G-3000, GI-1000, GI-3000 (all manufactured by Nippon Soda Co., Ltd.), R-45EPI (manufactured by Idemitsu Kosan Co., Ltd.), and the like can be mentioned.

As the diisocyanate compound, which is component (b) to be a starting material for the modified polyimide resin in the present invention, diisocyanates such as toluene-2,4-diisocyanate, toluene-2,6-diisocyanate, hexamethylene diisocyanate, xylylene diisocyanate, diphenylmethane diisocyanate, isophorone diisocyanate, and the like, and the like can be mentioned.

Specific examples of the tetracarboxylic acid dianhydride, which is component (c) as a starting material for the modified polyimide resin in the present invention include pyromellitic acid dianhydride, benzophenonetetracarboxylic acid dianhydride, biphenyltetracarboxylic acid dianhydride, naphthalenetetracarboxylic acid dianhydride, 5-(2,5-dioxotetrahydrofuryl)-3-methyl-cyclohexene-1,2-dicarboxylic acid anhydride, 3,3′-4,4′-diphenylsulfonetetracarboxylic acid dianhydride, 1,3,3a,4,5,9b-hexahydro-5-(tetrahydro-2,5-dioxo-3-furanyl)-naphto[1,2-C]furan-1,3-dione, and the like.

In the production of the modified polyimide resin in the present invention, the reaction between the bifunctional hydroxyl group-terminated polybutadiene and the diisocyanate compound can be carried out in an organic solvent under the conditions of a reaction temperature of not more than 80° C. and a reaction time of generally 1 to 8 hours. Where necessary, the reaction can be carried out in the presence of a catalyst. The reaction between the polybutadiene diisocyanate composition and the tetracarboxylic acid dianhydride can be carried out by cooling the solution containing the polybutadiene diisocyanate composition obtained by the above-mentioned reaction to room temperature, adding tetracarboxylic acid dianhydride thereto, and allowing the mixture to react under the conditions of a reaction temperature of 120 to 180° C. and a reaction time of 2 to 24 hours. The reaction is generally carried out in the presence of a catalyst. An organic solvent may be further added. The obtained reaction solution may be filtered as necessary to remove insoluble materials. The obtained reaction solution may be purified by adding a solvent that is a poor solvent to the modified polyimide, and separating the modified polyimide. Generally, however, such purification is not necessary, and the reaction solution can be used as it is as a modified polyimide resin varnish after filtration to remove insoluble materials and the like, if necessary. In the thus-obtained varnish modified polyimide resin, the amount of the solvent in the varnish can be appropriately adjusted by controlling the amount of the solvent during reaction, or adding a solvent after the reaction and the like. In addition, a modified polyimide resin having a higher molecular weight can be obtained by reaction with a diisocyanate after the reaction of the polybutadiene diisocyanate composition and the tetracarboxylic acid dianhydride. In this case, a diisocyanate compound is added dropwise to a reaction product of the polybutadiene diisocyanate composition and the tetracarboxylic acid dianhydride, and the reaction can be carried out under the conditions of a reaction temperature of 120 to 180° C. and a reaction time of 2 to 24 hours.

As the organic solvent to be used for each of the above-mentioned reactions, for example, polar solvents such as N,N′-dimethylformamide, N,N′-diethylformamide, N,N′-dimethylacetamide, N,N′-diethylacetamide, dimethylsulfoxide, diethylsulfoxide, N-methyl-2-pyrrolidone, tetramethylurea, γ-butyrolactone, cyclohexanone, diglyme, triglyme, carbitol acetate, propylene glycol monomethylether acetate, propyleneglycol monoethylether acetate, and the like can be mentioned. Two or more of these solvents may be used in a mixture. Where necessary, a nonpolar solvent such as aromatic hydrocarbon and the like can be also used after mixing as appropriate.

As the catalyst to be used for each of the above-mentioned reactions, for example, tertiary amines such as tetramethylbutanediamine, benzyldimethylamine, triethanolamine, triethylamine, N,N′-dimethylpiperidine, α-methylbenzyldimethylamine, N-methylmorpholine, triethylenediamine, and the like; organic metal catalysts such as dibutyltin laurate, dimethyltin dichloride, cobalt naphthenate, zinc naphthenate, and the like; and the like can be mentioned. Two or more of these catalysts may be used in a mixture. Particularly, as the catalyst, triethylenediamine is most preferably used.

As the “thermosetting resin,” which is component (B) in the present invention, for example, an epoxy resin; an urethane resin comprising a mixture of an isocyanate and a polyol or a mixture of block isocyanate and polyol, and the like; a bismaleimide resin, cyanate ester resin; a bisallylazide resin; a vinylbenzyl ether resin; a benzooxazine resin; a polymer of bismaleimide and diamine; and the like can be mentioned. Two or more of these thermosetting resins may be used in a mixture. As the thermosetting resin in the present invention, an epoxy resin is particularly preferable.

As the epoxy resin, for example, epoxy resin having not less than two functional groups in one molecule, such as bisphenol A epoxy resin, bisphenol F epoxy resin, phenol novolac epoxy resin, bisphenol S epoxy resin, alkylphenol novolac epoxy resin, biphenol epoxy resin, naphthalene epoxy resin, dicyclopentadiene epoxy resin, epoxydation product of a condensation product of phenol and aromatic aldehyde having a phenolic hydroxyl group, triglycidyl isocyanurate, alicyclic epoxy resin and the like, and the like can be mentioned. Two or more of these epoxy resins may be used in a mixture.

When an epoxy resin is used, an epoxy curing agent is generally necessary. As the epoxy curing agent, for example, an amine based curing agent, a guanidine based curing agent, an imidazole based curing agent, a phenol based curing agent, an acid anhydride based curing agent, a thiol based curing agent, or epoxy adducts of these, microcapsuled products thereof, and the like can be mentioned. Particularly, an imidazole based curing agent is preferable from the viewpoints of viscosity stability and the like when the resin composition is processed to give a printing ink. Two or more of the epoxy based curing agents may be used in a mixture. Moreover, an accelerator such as triphenylphosphine, phosphonium borate, 3-(3,4-dichlorophenyl)-1,1-dimethylurea, and the like may be concurrently used.

As specific examples of the epoxy curing agent, for example, dicyane diamide as an amine based curing agent; 2-ethyl-4-methylimidazole, 2-phenylimidazole, 2-phenylimidazole isocyanurate adduct, 2-phenyl-4-methyl-5-hydroxymethylimidazole (2P4 MHZ), 2,4-diamino-6-[2′-methylimidazolyl-(1′)]-ethyl-s-triazine (2MZ-A), 2,4-diamino-6-[2′-methylimidazolyl-(1′)]-ethyl-s-triazine isocyanurate adduct (2MA-OK) as imidazole based curing agents; and the like can be mentioned.

When the resin composition of the present invention is used as an overcoating agent for a flexible printed circuit board, a thermosetting resin of component (B) is preferably used within the range that affords a mass ratio of component (A):component (B) of 100:1 to 1:1. When the ratio of the resin of component (A) is greater than this value, the degree of crosslinking decreases and the chemical resistance tends to be degraded. When the ratio of the resin of component (A) is smaller than this value, the degree of crosslinking becomes too high and sufficient flexibility tends to be difficult to achieve. Moreover, the total content (100 mass %) of components (A) and (B) in the resin composition of the present invention is preferably not less than 60 mass %. As used herein, the total content of components (A) and (B) when the resin composition (e.g., resin composition varnish etc.) contains an organic solvent is calculated as the content of the components of the resin composition except the organic solvent. When it is less than 60 mass %, the resin composition may fail to provide a sufficient function of an overcoating agent.

As the “compound having 2 or more mercapto groups in a molecule and/or a compound having a disulfide bond in a molecule,” which is component (C) in the present invention, a thiol compound having 2 or more mercapto groups in one molecule such as 1,4-butanedithiol, p-xylene-α,α′-dithiol, 2,4,6-trimercapto-s-triazole, 2,5-dimercapto-1,3,4-thiadiazole, and the like; a compound having a disulfide bond in one molecule such as diethyl disulfide, diphenyl disulfide, dihexyl disulfide, dioctyl disulfide, and the like; and the like can be used. Preferred are, for example, 2,4,6-trimercapto-s-triazole and 2,5-dimercapto-1,3,4-thiadiazole.

Component (C) is preferably used within the range that affords a mass ratio of component (A):component (C) of 1000:1 to 10:1, more preferably 200:1 to 20:1. When the ratio of component (C) is smaller than this value, the effect of reducing warping tends to be insufficient. When the ratio is higher than this value, the problem of odor tends to occur, and the usable time of the overcoating agent tends to become shorter during preservation due to the increase in the viscosity.

The resin composition of the present invention may further contain a filler. The filler may be an organic filler or an inorganic filler. Two or more of the fillers may be used in a mixture. Use of an inorganic filler can increase the mechanical strength of a coating film. While the amount of the inorganic filler to be added is not particularly limited, the filler is preferably added within the range of 5 to 50 mass % of the resin composition. When it exceeds 50 mass %, application of the resin composition varnish to the surface of a flexible circuit board tends to become difficult, and the surface protecting film formed tends to have a higher elastic modulus that degrades toughness. When it is smaller than 5 mass %, a sufficient mechanical strength-improving effect tends to be difficult to achieve.

As the inorganic filler, silica, alumina, barium sulfate, talc, clay, mica powder, aluminum hydroxide, magnesium hydroxide, calcium carbonate, magnesium carbonate, magnesium oxide, boron nitride, aluminum borate, barium titanate, strontium titanate, calcium titanate, magnesium titanate, bismuth titanate, titanium oxide, barium zirconate, calcium zirconate, and the like can be mentioned. Particularly, silica and talc are preferable. An inorganic filler preferably has an average particle size of not more than 5 μm. As the organic filler, acrylic rubber particles, polyamide fine particles, silicone particles, and the like can be mentioned. As specific examples of the acrylic rubber particles, any resin fine particles made to be insoluble and infusible in organic solvents by chemically crosslinking resins showing rubber elasticity (e.g., acrylonitrile butadiene rubber, butadiene rubber, acrylic rubber, and the like) can be used and, for example, XER-91 (manufactured by Japan Synthetic Rubber Corporation), STAPHYLOID AC3355, AC3816, AC3832, AC4030, AC3364, IM101 (all manufactured by GANZ CHEMICAL CO., LTD.), Pararoid EXL2655, EXL2602 (all manufactured by Kureha Chemical Industry Co., Ltd.), and the like can be mentioned. As specific examples of the polyamide fine particles, any fine particles (not more than 50 micron) of a resin having an amide bond such as aliphatic polyamide (e.g., nylon), aromatic polyamide (e.g., Kevlar), polyamideimide, and the like can be used and, for example, VESTOSINT 2070 (manufactured by Daicel-Huls Ltd.), SP500 (manufactured by Toray Industries, Inc.), and the like can be mentioned. As the organic filler, those having an average particle size of not more than 5 μm are preferable. The average particle size can be measured by a laser diffraction/scattering particle size distribution analyzer LA-500 manufactured by HORIBA, Ltd.

The resin composition of the present invention can contain various resin additives, resin components other than components (A) and (B) and the like as long as the effect of the present invention can be exerted. As examples of the resin additive, for example, coupling agents such as a silane based coupling agent, a titanate based coupling agent, an aluminum based coupling agent, and the like; antifoaming agents such as a silicone antifoaming agent, a fluorine antifoaming agent, an acrylic polymer antifoaming agent, and the like; thickeners such as Orben, Benton, and the like; coloring agents such as phthalocyanine blue, phthalocyanine green, iodine green, disazo yellow, carbon black, and the like; flame-retardants such as a phosphorus containing compound, a bromine containing compound, an aluminum hydroxide, a magnesium hydroxide, and the like; leveling agents; thixotropic agents; and the like can be mentioned. As other resin components, polyester polyol resins, polyimide resins, polyamideimide resins, and the like can be mentioned.

When the resin composition of the present invention is used for surface protection of a flexible printed circuit board, namely, as an overcoating agent for a flexible printed circuit board, it is generally used in the form of a varnish prepared by adding an organic solvent to a resin composition. As the organic solvent used for preparing this varnish resin composition, or resin composition varnish, for example, ketones such as acetone, methyl ethyl ketone, cyclohexanone, and the like; acetic acid esters such as ethyl acetate, butyl acetate, cellosolve acetate, propyleneglycol monomethylether acetate, carbitol acetate, and the like; carbitols such as cellosolve, butylcarbitol, and the like; aromatic hydrocarbons such as toluene, xylene, and the like; dimethylformamide; dimethylacetamide; N-methylpyrrolidone; and the like can be mentioned. Two or more of these organic solvent may be used in combination. The resin composition varnish of the present invention is the resin composition of the present invention further containing an organic solvent, and is encompassed in the resin composition of the present invention. While the optimal content of the organic solvent in the varnish resin composition varies depending on the molecular structure, solubility in organic solvents and molecular weight of the resin and the like, it is preferably 20 to 60 mass %, more preferably 30 to 50 mass %, based on the total mass of the varnish.

By applying the resin composition varnish of the present invention to a given part of a flexible printed circuit board and drying the coated surface, a flexible printed circuit board wherein the entire surface or a part of the surface is protected by the resin composition of the present invention can be obtained. While the drying conditions can be easily determined as appropriate by those of ordinary skill in the art depending on the kind of the resin composition varnish to be used, the varnish is generally dried at 100 to 200° C. for about 1 to 120 minutes. While the thickness of the surface protecting film to be formed is not particularly limited, either, it is generally 5 to 100 μm. The flexible printed circuit board whose surface is to be protected by the resin composition of the present invention is not particularly limited, and the resin composition can be used for various flexible printed circuit boards such as flexible printed circuit board for a TAB, a flexible printed circuit board for COF, a multi-layer flexible printed circuit board, a conductive paste printing flexible printed circuit board, and the like, and particularly preferably used for flexible printed circuit board for a TAB and flexible printed circuit board for a COF.

A flexible printed circuit board having a surface protected by the resin composition of the present invention is used after being built into various electronic devices. For example, it is preferably used as internal wiring of various electronic devices such as a cell phone, a digital camera, a video camera, a game console, a personal computer, a printer, a hard disc drive, a plasma television, a liquid crystal television, a liquid crystal display, a car navigation system, a copying machine, a facsimile, audio-video equipment, a measurement device, medical equipment, and the like.

Other features of the invention will become apparent in the course of the following descriptions of exemplary embodiments which are given for illustration of the invention and are not intended to be limiting thereof.

### EXAMPLES

In the following examples, “part” means parts by mass.

Production of Modified Polyimide Resin Varnish A.

G-3000 (50 g, bifunctional hydroxyl group-terminated polybutadiene, number average molecular weight=5047 (GPC method), hydroxyl group equivalent weight=1798 g/eq., solid content 100 mass %: manufactured by Nippon Soda Co., Ltd.), IPSOL 150 (23.5 g, aromatic hydrocarbon mixed solvent: manufactured by Idemitsu Kosan Co., Ltd.), and dibutyltin laurate (0.005 g) were mixed in a reaction vessel and uniformly dissolved therein. When the mixture became uniform, it was heated to 50° C., and toluene-2,4-diisocyanate (4.8 g, isocyanate group equivalent=87.08 g/eq.) was added, and the reaction was carried out for about 3 hours with stirring. Then, this reaction product was cooled to room temperature, and benzophenonetetracarboxylic acid dianhydride (8.96 g, acid anhydride group equivalent weight=161.1 g/eq.), triethylenediamine (0.07 g), and ethyldiglycol acetate (40.4 g, manufactured by Daicel Chemical Industries, Ltd.) were added. The mixture was heated to 130° C. with stirring and the reaction was carried out for about 4 hours. The disappearance of NCO peak (2250 cm⁻¹) was confirmed with FT-IR. The disappearance of the NCO peak was taken as the end point of the reaction, and the reaction product was cooled to room temperature and filtered through a 100 mesh filter cloth to give a modified polyimide resin varnish A.

Properties of Modified Polyimide Resin Varnish A:

viscosity=7.5 Pa·s (25° C., E type viscosimeter)

acid value=16.9 mg KOH/g

solid content (components other than solvent)=50 mass %

number average molecular weight=13723

content of polybutadiene structure portion=50×100/(50+4.8+8.96)=78.4 mass %

Production of Modified Polyimide Resin Varnish B.

G-3000 (50 g, bifunctional hydroxyl group-terminated polybutadiene, number average molecular weight=5047 (GPC method), hydroxyl group equivalent weight=1798 g/eq., solid content 100 mass %: manufactured by Nippon Soda Co., Ltd.), IPSOL 150 (23.5 g, aromatic hydrocarbon mixed solvent: manufactured by Idemitsu Kosan Co., Ltd.), and dibutyltin laurate (0.007 g) were mixed in a reaction vessel and uniformly dissolved therein. When the mixture became uniform, it was heated to 50° C., and toluene-2,4-diisocyanate (4.8 g, isocyanate group equivalent weight=87.08 g/eq.) was added, and the reaction was carried out for about 3 hours with stirring. Then, this reaction product was cooled to room temperature, and benzophenonetetracarboxylic acid dianhydride (8.83 g, acid anhydride group equivalent weight=161.1 g/eq.), triethylenediamine (0.07 g), and ethyldiglycol acetate (74.09 g, manufactured by Daicel Chemical Industries, Ltd.) were added. The mixture was heated to 130° C. with stirring and the reaction was carried out for about 4 hours. When the disappearance of NCO peak (2250 cm⁻¹) was confirmed with FT-IR, toluene-2,4-diisocyanate (1.43 g, isocyanate group equivalent weight=87.08 g/eq.) was further added, and the disappearance of NCO peak was confirmed again with FT-IR while carrying out the reaction with stirring at 130° C. for 2 to 6 hours. The disappearance of the NCO peak was taken as the end point of the reaction, and the reaction product was cooled to room temperature and filtered through a 100 mesh filter cloth to give a modified polyimide resin varnish B.

Properties of Modified Polyimide Resin Varnish B:

viscosity=7.0 Pa·s (25° C., E type viscosimeter)

acid value=6.9 mg KOH/g

solid content=40 mass %

number average molecular weight=19890

content of polybutadiene structure portion=50×100/(50+4.8+8.83+1.43)=76.9 mass %

Properties of Other Resin Varnishes:

(i) polybutadiene polyol (G-1000, manufactured by Nippon Soda Co., Ltd., OH terminated polybutadiene, solid content 100 mass %);

(ii) cresol novolac epoxy resin varnish (N695, Dainippon Ink And Chemicals, Incorporated, carbitol acetate solution, solid content 80 mass %);

(iii) dicyclopentadiene epoxy resin varnish (HP7200, Dainippon Ink And Chemicals, Incorporated, carbitol acetate solution, solid content 80 mass %); and

(iv) polyester polyol (VYLON-200, Toyo Boseki Kabushiki Kaisha, OH terminated polyester polyol, carbitol acetate/petroleum naphtha=2/1 solution, solid content 45 mass %).

Production of Polybutadiene Polyblock Isocyanate Resin Varnish.

HTP-9 (1000 g, manufactured by Idemitsu Kosan Co., Ltd., NCO terminated polybutadiene, NCO equivalent weight=467 g/eq., solid content=100 mass %), carbitol acetate (216 g), and dibutyltin dilaurate (0.1 g) were mixed in a reaction vessel and uniformly dissolved therein. When the mixture became uniform, it was heated to 70° C., and methylethylketone oxime (214 g) was added dropwise over 2 hours with stirring, and the mixture was maintained for 1 hour. When the disappearance of NCO peak (2250 cm⁻¹) was confirmed with FT-IR, the reaction mixture was cooled to give a polybutadiene polyblock isocyanate resin varnish.

Properties of Polybutadiene Polyblock Isocyanate Resin Varnish:

NCO equivalent weight=672.5 g/eq., solid content 85 mass %

Evaluation Method of Surface Protecting Film.

1. Warp test: The resin composition was applied onto a polyimide film (length 35 mm×width 60 mm×thickness 40 μm) within the range of 25 mm×35 mm at a thickness of 15 μm, and the amount of warp after curing was measured under the following conditions. For the measurement of the amount of warp, the film was placed on a leveling table with the coating film surface facing downward and the height (mm) of the warp was measured and evaluated. Conditions: A test piece cured at 120° C. for 90 minutes was aged at 150° C. for 100 hours.

Evaluation Criteria:

⊙: The amount of warp is not more than 0.2 mm.

∘: The amount of warp is not more than 1.0 mm.

x: The amount of warp exceeds 1.0 mm.

2. Anti-bending property (flexibility) test: The resin composition was applied onto a polyimide film (length 35 mm×width 60 mm×thickness 40 μm) within the range of 25 mm×35 mm at a thickness of 15 μm, and test piece cured at 120° C. for 90 minutes was bent 180°, and the surface of the coating film was observed.

∘: No change is observed in coating film before and after bending.

Δ: Partial change is observed in coating film before and after bending.

x: Change is observed in coating film before and after bending.

3. Heat resistance: ILB (Inner Lead Bonding) heat resistance simulation test: The resin composition was applied at a thickness of 15 μm onto a polyimide substrate having a copper wiring pattern (40 μm pitch) formed thereon and cured at 120° C. for 90 minutes to give a test piece. An ILB bonder heating tool was contacted with the boundary between the resin composition application site and the non-application site on the pattern for 2 seconds, and the presence or absence of swelling of the resin composition was observed. When the swelling was absent, the temperature of the heating tool was raised by 10° C., and a similar operation was repeated. The critical temperature free of swelling was taken as the heat resistant temperature.

4. Chemical resistance: The resin composition was applied onto a polyimide film (length 35 mm×width 60 mm×thickness 40 μm) within the range of 25 mm×35 mm at a thickness of 15 μm, and test piece cured at 120° C. for 90 minutes was immersed in 1M hydrochloric acid for 30 minutes, and the appearance of the coating film was observed.

∘: No change is observed in coating film before and after immersion.

Δ: Partial change is observed in coating film before and after immersion.

x: Change is observed in coating film before and after immersion.

5. Solvent resistance: The resin composition was applied onto a polyimide film (length 35 mm×width 60 mm×thickness 40 μm) within the range of 25 mm×35 mm at a thickness of 15 μm, and the coating film on the test piece cured at 120° C. for 90 minutes was rubbed with a waste impregnated with acetone, and the appearance of the coating film was observed.

∘: No change is observed in coating film before and after rubbing.

Δ: Partial change is observed in coating film before and after rubbing.

x: Change is observed in coating film before and after rubbing.

6. Electrical insulation: The resin composition was applied at a thickness of 15 μm onto a polyimide substrate having a comb-like copper wiring pattern (30 μm pitch) and cured at 120° C. for 90 minutes. The resulting test piece was left standing in an environment of 25±3° C., 50±10% RH for not less than 2 hours, and the insulation resistance (initial value) was measured. The test piece was placed in a thermostat/humidistat bath at 85±2° C., 85±2% RH and 60V was applied. After the lapse of 1000 hours, the test piece was left standing in an environment of 25±3° C., 50±10% RH for not less than 2 hours, and the insulation resistance was measured.

### Example 1

According to Example 1 in Table 1, the respective components (A) to (E) were added and kneaded using a three-roll mill. The mixture was adjusted to the viscosity of 20±2 Pa·S using carbitol acetate and petroleum naphtha as viscosity adjusting solvents to give a resin composition varnish. The obtained resin composition varnish was applied to substrates for respective evaluations at the given film thickness, and dried and cured at 120° C. for 90 minutes to give test samples.

### Example 2

According to Example 2 in Table 1, the respective components were added and test samples were prepared in the same manner as in Example 1.

### Example 3

According to Example 3 in Table 1, the respective components were added and test samples were prepared in the same manner as in Example 1.

### Example 4

According to Example 4 in Table 1, the respective components were added and test samples were prepared in the same manner as in Example 1.

### Example 5

According to Example 5 in Table 1, the respective components were added and kneaded using a three-roll mill. Component (G) was added and the mixture was stirred in a planetary mixer. The mixture was adjusted to the viscosity of 20±2 Pa·S using carbitol acetate and petroleum naphtha as viscosity adjusting solvents to give a resin composition varnish. The test samples were prepared in the same manner as in Example 1.

### Example 6

According to Example 6 in Table 1, the respective components were added and test samples were prepared in the same manner as in Example 1.

### Comparative Examples 1-3

According to Comparative Examples 1-3 in Table 1, the respective components were added and test samples were prepared in the same manner as in Example 1.

TABLE 1

| | | | | | | | | Com. | Com. | Com. |
|---|---|---|---|---|---|---|---|---|---|---|
| Component | | Ex. 1 | Ex. 2 | Ex. 3 | Ex. 4 | Ex. 5 | Ex. 6 | Ex. 1 | Ex. 2 | Ex. 3 |
| (A) | modified polyimide varnish A (solid content 50 mass %) | | | 80 | 80 | | | | 80 | |
| | modified polyimide varnish B (solid content 40 mass %) | 80 | 80 | | | | 80 | 80 | | |
| | polybutadiene polyol (G-1000, solid content 100 mass %) | | | | | 30 | 42 | | | 30 |
| (G) | polyester polyol (VYLON-200, solid content 45 mass %) | | | | | 45 | | | | 45 |
| (B) | cresol novolac epoxy resin varnish (N695, solid content 80 | 15 | 15 | | | | | 15 | | |
| | mass %) | | | | | | | | | |
| | dicyclopentadiene epoxy resin varnish (HP7200) | | | 30 | 30 | | | | 30 | |
| | biphenyl epoxy resin (YX4000) | 10 | 10 | | | | | 10 | | |
| | biphenol A epoxy resin (EP828) | 5 | 5 | | | | | 5 | | |
| | block isocyanate resin (HTP-9 blocked with MEK, solid | | | | | 27 | 60 | | | 27 |
| | content 85%) | | | | | | | | | |
| (C) | dioctyl disulfide | 1.5 | | 2 | | 1 | 1.5 | | | |
| | 2,4,6-trimercapto-s-triazole | | 1 | | | | | | | |
| | 2,5-dimercapto-1,3,4-thiadiazole | | | | 2 | | | | | |
| (D) | 2MZ-A | 2 | | 2 | | | | | 2 | |
| | 2P4MHZ | | 2 | | | | | 2 | | |
| | 2MA-OK | | | | 2 | | | | | |
| (E) | silica (average particle size 8 μm) | 25 | | 25 | | | | | 25 | |
| | talc (average particle size 2.5 μm) | | 15 | | 15 | | | 15 | | |
| | AEROSIL A-200 | 1 | 1 | 1 | 1 | 1 | 1 | 1 | 1 | 1 |
| | rubber particles (AC3355) | 5 | 10 | 5 | 10 | | 7.5 | 10 | 5 | |
| (F) | petroleum naphtha (#150) | q.s. | q.s. | q.s. | q.s. | q.s. | q.s. | q.s. | q.s. | q.s. |
| | EDGAC (carbitol acetate) | q.s. | q.s. | q.s. | q.s. | q.s. | q.s. | q.s. | q.s. | q.s. |

*) The numerical values in Table 1 show parts by mass containing solvents in the starting materials.
*) In Table 1, Aerosil A-200: ultrafine silica particles, manufactured by NIPPON AEROSIL CO., LTD.

The evaluation of each item was performed for Examples 1-6 and Comparative Examples 1-3, and the results are summarized in Table 2.

TABLE 2

| | | | | | | | | Com. | Com. | Com. |
|---|---|---|---|---|---|---|---|---|---|---|
| | | Ex. 1 | Ex. 2 | Ex. 3 | Ex. 4 | Ex. 5 | Ex. 6 | Ex. 1 | Ex. 2 | Ex. 3 |
| Warp | 120° C./ | ◯ | ⊙ | ◯ | ⊙ | ◯ | ◯ | X | X | X |
| | 90 min + 150° C./ | | | | | | | | | |
| | 100 hr | | | | | | | | | |
| Bending | 180° C. | Δ | ◯ | Δ | ◯ | ◯ | ◯ | ◯ | Δ | ◯ |
| | bending | | | | | | | | | |
| Heat resistance | ILB heat resistance | 500 | 500 | 500 | 500 | 400 | 450 | 490 | 490 | 400 |
| | simulation test (° C.) | | | | | | | | | |
| Chemical | hydrochloric acid | ◯ | ◯ | ◯ | ◯ | Δ | Δ | ◯ | ◯ | Δ |
| resistance | immersion | | | | | | | | | |
| Solvent | acetone rubbing | ◯ | ◯ | ◯ | ◯ | Δ | Δ | ◯ | ◯ | Δ |
| resistance | | | | | | | | | | |
| Electric | insulation resistance | 1.0E+11 | 1.0E+11 | 1.0E+11 | 1.0E+11 | 1.0E+11 | 1.0E+11 | 1.0E+11 | 1.0E+11 | 1.0E+11 |
| properties | value (initial value) | | | | | | | | | |
| | insulation resistance | 1.0E+09 | 1.0E+09 | 1.0E+10 | 1.0E+10 | 1.0E+06 | 1.0E+07 | 1.0E+09 | 1.0E+10 | 1.0E+06 |
| | value (after 1000 hrs) | | | | | | | | | |

It is clear that the resin compositions of Examples 1-6 are superior in flexibility and warping upon curing, and further, in chemical resistance, heat resistance, and electrical insulation, as compared to the resin compositions of Comparative Examples.

Obviously, numerous modifications and variations of the present invention are possible in light of the above teachings. It is therefore to be understood that, within the scope of the appended claims, the invention may be practiced otherwise than as specifically described herein.

All patents and other references mentioned above are incorporated in full herein by this reference, the same as if set forth at length.

1. A resin composition, comprising:
(A) at least one resin having a polybutadiene structure in a molecule;
(B) at least one thermosetting resin; and
(C) at least one compound having 2 or more mercapto groups in a molecule or at least one compound having a disulfide bond in a molecule.

2. The resin composition of claim 1, wherein said at least one resin having a polybutadiene structure in a molecule (A) comprises a resin having a polybutadiene structure and a polyurethane structure in a molecule.

3. The resin composition of claim 1, wherein said at least one resin having a polybutadiene structure in a molecule (A) comprises a resin having a polybutadiene structure, a polyurethane structure, and a polyimide structure in a molecule.

4. The resin composition of claim 1, wherein said at least one resin having a polybutadiene structure in a molecule (A) comprises a modified polyimide resin obtained by reacting a bifunctional hydroxyl group-terminated polybutadiene, a diisocyanate compound, and a tetracarboxylic acid dianhydride.

5. The resin composition of claim 1, wherein said at least one resin having a polybutadiene structure in a molecule (A) comprises a modified polyimide resin obtained by reacting a tetracarboxylic acid dianhydride with a polybutadiene diisocyanate composition, wherein said polybutadiene diisocyanate composition is obtained by reacting a bifunctional hydroxyl group-terminated polybutadiene with a diisocyanate compound in relative amounts such that the functional group equivalent ratio of isocyanate groups of said diisocyanate compound to hydroxyl groups of said bifunctional hydroxyl group-terminated polybutadiene is greater than 1.

6. The resin composition of claim 1, wherein said at least one resin having a polybutadiene structure in a molecule (A) comprises a modified polyimide resin obtained by reacting a tetracarboxylic acid dianhydride with a polybutadiene diisocyanate composition, wherein said polybutadiene diisocyanate composition is obtained by reacting a bifunctional hydroxyl group-terminated polybutadiene with a diisocyanate compound in relative amounts such that the functional group equivalent ratio of hydroxyl groups of said bifunctional hydroxyl group-terminated polybutadiene:isocyanate groups of said diisocyanate compound is 1:1.5 to 1:2.5.

7. The resin composition of claim 1, wherein said at least one resin having a polybutadiene structure in a molecule (A) comprises a modified polyimide resin obtained by reacting a bifunctional hydroxyl group-terminated polybutadiene with a diisocyanate compound in relative amounts such that the functional group equivalent ratio of hydroxyl groups of said bifunctional hydroxyl group-terminated polybutadiene to isocyanate groups of said diisocyanate compound is 1:1.5 to 1:2.5, to obtain a a polybutadiene diisocyanate composition, and by reacting said polybutadiene diisocyanate composition with a tetracarboxylic acid dianhydride at a ratio such that the functional group equivalent X of the isocyanate groups of starting material diisocyanate compound, the functional group equivalent W of hydroxyl groups of starting material bifunctional hydroxyl-terminated polybutadiene, and the functional group equivalent Y of acid anhydride groups of said tetracarboxylic acid dianhydride satisfy the relation of Y>X−W≧Y/5 (W>0, X>0, Y>0).

8. The resin composition of claim 4, wherein said modified polyimide resin comprises a modified polyimide resin obtained by obtained by reacting a bifunctional hydroxyl-terminated polybutadiene, a first diisocyanate compound, and a tetracarboxylic acid anhydride, to obtain a modified linear polyimide resin and then further reacting said modified linear polyimide resin with an additional isocyanate compound in a ratio such that the functional group equivalent X of isocyanate groups of said first diisocyanate compound, the functional group equivalent W of hydroxyl groups of said bifunctional hydroxyl-terminated polybutadiene, the functional group equivalent Y of acid anhydride groups of said tetracarboxylic acid dianhydride, and the functional group equivalent Z of isocyanate groups of said additional isocyanate compound satisfy the relation of Y−(X−W)>Z≧0(W>0, X>0, Y>0, Z>0).

9. The resin composition of claim 4, wherein said bifunctional hydroxyl group-terminated polybutadiene has a number average molecular weight of 800 to 10000.

10. The resin composition of claim 1, wherein said at least one resin having a polybutadiene structure in a molecule (A) comprises a resin having a polyurethane structure represented by the following formula (1-a): 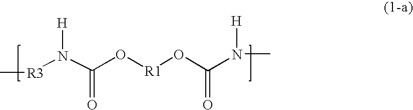
wherein R1 is a residue obtained by removing hydroxyl groups from a bifunctional hydroxyl group-terminated polybutadiene, and R3 is a residue obtained by removing isocyanate groups from a diisocyanate compound.

11. The resin composition of claim 1, wherein said at least one resin having a polybutadiene structure in a molecule (A) comprises a modified polyimide resin having, in a molecule, a polybutadiene structure represented by the following formula (1-a): 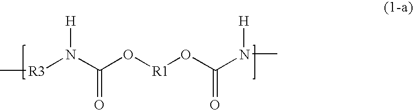
wherein R1 is a residue obtained by removing hydroxyl groups from a bifunctional hydroxyl group-terminated polybutadiene, and R3 is a residue obtained by removing isocyanate group from a diisocyanate compound
and a polyimide structure represented by the formula (1-b) 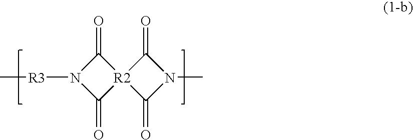
wherein R2 is a residue obtained by removing acid anhydride groups from a tetracarboxylic acid dianhydride, and R3 is as defined above.

12. The resin composition of claim 1, wherein said at least one thermosetting resin (B) comprises an epoxy resin.

13. The resin composition of claim 12, further comprising an epoxy curing agent.

14. The resin composition of claim 1, wherein a mass ratio of said at least one resin having a polybutadiene structure in a molecule (A) to said at least one thermosetting resin (B) is 100:1 to 1:1, and the total content of said at least one resin having a polybutadiene structure in a molecule (A) and said at least one thermosetting resin (B) in said resin composition is not less than 60 mass %, based on the total mass of said resin composition.

15. The resin composition of claim 1, wherein a mass ratio of said at least one resin having a polybutadiene structure in a molecule (A) to said at least one compound having 2 or more mercapto groups in a molecule or at least one compound having a disulfide bond in a molecule (C) is 1000:1 to 10:1.

16. The resin composition of claim 1, further comprising a filler.

17. The resin composition of claim 16, wherein the content of said finer in the resin composition is 5 to 50 mass %, based on the total mass of said resin composition.

18. The resin composition of claim 1, which is a varnish resin composition further comprising an organic solvent.

19. The resin composition of claim 18, wherein said organic solvent is present in said resin composition in an amount of 20 to 60 mass %, based on the total mass of said resin composition.

20. The resin composition of claim 1, which comprises at least one compound having 2 or more mercapto groups in a molecule and at least one compound having a disulfide bond in a molecule.

21. A flexible printed circuit board, having a surface protected by a resin composition of claim 1.

22. A flexible printed circuit board having a protected surface, which is obtained by applying a varnish of the resin composition of claim 18 to a given part of a flexible printed circuit board and drying said varnish.

23. An electronic device, comprising a flexible printed circuit board of claim 21.
